(19) United States
(12) Patent Application Publication
(10) Pub. No.: US 2009/0278929 A1
(43) Pub. Date: Nov. 12, 2009

(54) Video camera with interchangable optical sensors

(75) Inventors: Nicholas J. Lagadinos, Billerica, MA (US); Cheryl A. Casper, North Chemlsford, MA (US); Stephen V. McKaughan, Arlington, MA (US)

Correspondence Address: THE H.T. THAN LAW GROUP, WATERFRONT CENTER SUITE 560, 1010 WISCONSIN AVENUE NW, WASHINGTON, DC, 20007, US

(73) Assignee: FLIR SYSTEMS INC, North Billerica, MA (US)

(21) Appl. No.: 12/151,381

(22) Filed: May 6, 2008

(51) Int. Cl. H04N 7/18; H04N 5/225

(52) U.S. Cl. 348/143; 348/217.1; 348/374; 348/E07.085; 348/E05.09

(57) ABSTRACT

A video camera 100 for remote operation or surveillance has a lens system 1 supported on a fixed base plate 26 and a pair of image sensors 14, 15, 204 mounted onto a movable plate 13. A pair of balls slides 11, 12 are attached to the fixed base plate 26 and the movable plate 13 to provide linear movement of the movable plate along a linear motion axis 50. An actuator 5 is disposed between the fixed base plate 26 and the movable plate 13 to move the movable plate 13 and each of the image sensors 14, 15, 204 along the linear motion axis 50 to dispose either the first image sensor 14 or the second image sensor 15 in and imagining position where the lens system 1 forms a scene image onto its active surface. In a preferred embodiment, the first image sensor 14 is an Electron Multiplication CCD array suitable for night time imaging and the second sensor 15 is a color CCD array suitable for day light imaging. The invention allows for multiple resolutions, multiple fields of view, multiple spectral bands or all three capabilities using a single lens system 1 without the efficiency losses in photon gathering and other shortcomings of other techniques commonly in use today.

### BACKGROUND OF THE INVENTION

1. Field of the Invention

The present invention relates to a video camera having a fixed optical system and two movable photo-sensors. In particular, the camera includes a fixed optical system forming a scene image at an image plane, and a movable plate configured to position either one of two photo-sensors in the image plane to render a video image of the scene with either one of the two photo-sensors.

2. Description of the Related Art

Video cameras are used in surveillance applications to capture video images of a scene. In some applications, it is desirable to render video images of the scene in the visible spectrum, (e.g. wavelengths in the range of 400-650 nm), in daylight, or other high scene illumination conditions, and in lowlight or other low scene illumination conditions such as at night or indoors. While video camera systems equipped with conventional visible spectrum Charge Coupled Device (CCD) color image sensors are suitable for day time use, conventional visible spectrum CCD color image sensors generally do not have enough sensitivity to render video image at night or under low scene illumination conditions. The problem has historically been solved by illuminating the scene, e.g. using a flash lamp or laser illuminator attached to the camera system; however, illuminating a scene is not always practical, especially when the scene is more than about 10 meters from the camera system.

Typical daylight illuminated scenes have illumination levels ranging from about 400 lux at dawn or dusk to about 100 Klux, at maximum sunlight conditions on an average day. The illumination of an artificially lighted indoor scenes ranges from about 50-400 lux and the illumination of night time scenes range from about 50 μlx (microlux), in moonless starlight, to 0.25 lux on a clear moonlit night. While some conventional CCD video cameras are capable of rending a color video image of a scene illuminated with 0.8 lux, these cameras are not suitable for night time or other lowlight imaging.

To solve the problem of night time or lowlight imaging, it is know to use a video camera equipped with an image intensifier module. For example, an image intensifier is positioned between a video camera lens system and a video camera CCD sensor. The lens system collects illumination from the scene, the image intensifier amplifies the illumination, and the amplified illumination is directed onto the CCD image sensor. The amplified illumination is above the illumination threshold of the CCD sensor, and a video image of night time or other low light scenes can be rendered without illuminating the scene. However, color information from the scene is lost during the amplification process and image intensified images are black and white images.

In a conventional image intensifier module, scene illumination amplification results when illumination collected from the scene is directed onto a photo-cathode plate which emits electrons in response to photon energy from the scene. The electrons are directed to a micro channel plate which accelerates the electrons and creates more electrons. The increased electron flow is directed to a phosphor screen and causes the phosphor screen to emit photons by luminescence. All of photons emitted by the phosphor screen have substantially the same wavelength. The photons emitted by the phosphor screen are directed onto an active surface of the CCD video sensor, which renders a video image according to the image displayed on the phosphor screen. The gain of the optical amplification can be adjusted by varying the electrical potential of the photo-cathode plate. The image intensifier tube operates more efficiently when a fiber optic bundle is coupled between the phosphor screen and the CCD video sensor to deliver more of the luminescence energy to the CCD video sensor.

While a video camera equipped with an image intensifier tube provides video images of scenes having low illumination conditions, the images are black and white images. Accordingly, conventional video camera systems designed for both day and night imaging generally utilize two distinct video cameras with one camera including an image intensifier and another camera including a conventional visible spectrum CCD sensor.

One example of a two camera system is disclosed by Williams in U.S. Pat. No. 6,262,768 which describes a camera system comprising a color CCD camera for daylight image recording, and a low light sensing black and white CCD camera for low light image recording. Both cameras are housed in a single enclosure and pointed at the same scene. A remotely controlled pan tilt unit points the enclosure at a desired scene. A remote video monitor receives image data either from the color CCD camera or the black and white CCD camera and displays one or the other. Each camera includes its own motorized adjustable zoom lens and motorized adjustable lens iris for varying image magnification of the scene image and the radiant energy entering the cameras. In one embodiment, the black and white CCD camera includes a third generation image intensifier for amplifying radiant energy received from the scene. In examples cited by Williams, the color CCD camera has a scene illumination sensitivity threshold of approximately 2 lux; while the image intensified black and white CCD camera has a scene illumination sensitivity of approximately 0.00002 lux. While the Williams camera system example provides useful day and night video imaging capability, the use of two distinct camera systems increases the system volume, weight, cost and complexity.

An improved daylight/lowlight video camera system is disclosed by Johnson et al. in U.S. Pat. No. 5,373,320, which describes a single video camera equipped to render a video image of a scene illuminated by daylight conditions or illuminated by low light conditions such as at night. The video camera system disclosed by Johnson et al. includes a single lens system for collecting radiant energy from a scene, a single CCD camera sensor for forming a video image of the scene, and an image intensifier element configured to move from an unused position for daylight imaging to a position between the lens system and the CCD sensor for low light or night time imaging. In particular, an image intensifier tube is supported on a rotating disk in a manner that allows the image intensifier tube to be rotated into an optical path between the lens system and the CCD camera sensor in the event that the radiant energy collected from the scene needs to be amplified. However, because the image intensifier tube disclosed by Johnson et al. is movable with respect to the CCD camera sensor, the system lacks a fiber optic bundle coupled between the phosphor screen and the CCD sensor, and this reduces the coupling efficiency between the phosphor screen and the CCD sensor. To compensate, Johnson et al. turned up the image intensifier gain. However the increase in system gain increases image noise and generally degrades the quality of the video image rendered.

In either example cited above, the image intensifier module adds weight, cost and complexity to the camera system. Moreover, the process of amplifying scene illumination destroys spectral information, reduces image sharpness and contributes to additional image noise. Accordingly there is a need for an improved day/night imaging camera with improve low light image quality, reduced weight, cost and complexity.

More recent developments in CCD image sensors have provided a Charge Carrier Multiplication (CCM) device that multiplies photo stimulated charges collected from individual image sensors before the charges are converted to a voltage signal. In particular the TEXAS INSTRUMENT Model TC253SPD-B0 electron multiplication CCD sensor is configured to multiply charge by applying multiplication pulses to gates specially designed to activate the CCM device. This produces a very-low noise, high sensitivity image sensor capable of rendering high contrast black and white video images of a scene with a scene illumination threshold performance similar to that provided by conventional image intensifier modules, e.g. down to about 2 μlx. In addition, the aforementioned commercially available CCM configured CCD has ⅓ inch format or active area size (4.8×3.6 mm) with an array of 656×496 sensor elements and a Pelletier cooled package to increase signal to noise ratio. Accordingly, the CCM CCD sensor is usable instead of a conventional image intensifier for night time surveillance. Moreover the CCM CCD is also usable for daylight surveillance. However, the CCM CCD sensor only produces a black and white image and the need to render color visible spectrum video images of a scene in daytime conditions can not be met by the CCM CCD sensor alone.

### SUMMARY OF THE INVENTION

It is an object of the present invention to provide a camera system configured with a fixed lens system and with a plurality of photo sensors wherein each photo sensor is movable to an imaging position to render a color video image of a scene in daylight or other suitable scene illumination conditions, and to render a black and white video image of the scene in lowlight illumination conditions such as at night.

It is a further object of the present invention to provide a video camera system suitable for daytime and nighttime operation that is more compact and light weight than conventional daytime and nighttime camera systems.

It is further object of the present invention to provide a video camera system configured with a fixed lens system and with multiple photo sensors supported for movement to an imaging position behind the fixed lens and to render a video image of a scene different image sensors without shifting the position of objects in a scene.

It is a further object of the present invention to provide a video camera system configured with a fixed lens system and with multiple photo sensors supported for movement to an imaging position behind the fixed lens and to render video images of a scene over different spectral bandwidths.

It is a further object of the present invention to provide a video camera system configured with a fixed lens system and with multiple photo sensors supported for movement to an imaging position behind the fixed lens and to render video images of a scene with different fields of view and or different resolutions

The present invention overcomes the problems cited in the prior art by providing a video camera system 100 having a single lens system 1 and two image sensors 14, 15 each capable of being moved to an imaging position behind the lens system 1. In a preferred embodiment, the lens system is a telescope optical system 1 including movable zoom elements 46, 47 for changing the field of view of the telescope optical system. The lens system 1 forms a planar scene image at an image plane 43 and the scene image is centered with respect to an optical axis 45. Other lens systems including reflective designs are usable.

The camera system includes a fixed base plate 26 that supports the telescope 1 thereon. The fixed base 26 may be supported on a motorized gimbal mount 208, or the like, for attaching the camera to a fixed structure or a moving vehicle. The motorized gimbal mount 208 is usable to point the camera system 100 at a scene or a specific target within a scene and the motorized gimbal mount 208 may be associated with a target tracking system, a gyro-stabilization system, a user pointing interface, and other gimbal control systems. Alternately, the camera system 100 may be configured as a hand held video camera.

A pair of ball slides 11, 12 each comprises a first element fixedly attached to the fixed base plate 26 and a second element fixedly attached to a movable plate 13. The balls slides 11, 12 provide linear movement between the first elements and the second elements. The linear movement is along a linear motion axis 50 and the ball slides are aligned with their linear motion axes orthogonal to the optical axis 45. Accordingly the movable plate 13 is movable along the linear motion axis 50.

In a preferred embodiment each of the image sensors 14, 15 comprise a focal plane array. A first focal plane array 14 is attached to the movable plate 13 in a first position and a second focal plane array 15 is attached to the movable plate 13 in a second position. The camera system 100 includes a first video image rendering system associated with the first focal plane array 14 and a second video image rendering system associated with the second focal plane array 15.

In a second embodiment, the first image sensor 14 comprises a focal plane array and an associated video rendering system for rendering a video image of a scene and the second image sensor 15 comprises a photo diode formed as a quadrant detector 204 and an associated signal processing system usable to point the camera system 100 at a bright spot in a scene such as a target illuminated by a light source or the like. In addition, signals generated by the quadrant detector may be communicated to a gimbal controller 210 to precisely point the camera system 100 at the bright spot in the scene.

An actuator mechanism 5 such as a rotary motor or a linear actuator is attached to the fixed base plate 26 and configured to move the movable plate 13 and each of the photo sensors 14, 15 along the linear motion axis 50 in response to input signals. The input signals cause the actuator to position one of the first photo sensor 14 or the second photo sensor 15 into an imaging position wherein the telescope optical system 1 forms a scene image onto an active area of the photo sensor in the imaging position.

The invention further provides a method for rendering video images of a scene using different image sensors by supporting an optical system 1 on the fixed base plate 26 and forming scene image at an imaging position. The method includes supporting a plurality of image sensors on a moveable plate 13 and moving the movable plate 13 with respect to the optical system 1 to position a selected one of the plurality of image sensors into the imaging position. Thereafter a video imaging system associated with the selected one of the plurality of image sensors in the imaging position is used to render a video image of the scene.

In a preferred embodiment the camera system 100 includes a first image sensor 14 for rending video image at night or in low light conditions and a second image sensor 15 for rendering color video images in daylight conditions. The camera system 100 may also include automated systems for switching from one image sensor to another in response to illumination levels in a scene.

### BRIEF DESCRIPTION OF THE DRAWINGS

The features of the present invention will best be understood from a detailed description of the invention and a preferred embodiment thereof selected for the purposes of illustration and shown in the accompanying drawings in which:

FIG. 1A illustrates telescope zoom optical train with zoom elements positioned for a wide field of view according to one aspect of the invention;

FIG. 1B illustrates telescope zoom optical train with zoom elements positioned for a narrow field of view according to one aspect of the invention;

FIG. 2 illustrates an isometric front view of a video camera system according to the present invention;

FIG. 3 illustrates an exploded isometric front view of a video camera system according to the present invention;

FIG. 4 illustrates an isometric rear view of portions of a video camera system according to the present invention;

FIG. 5 illustrates a top exploded view of a video camera system according to the present invention; and,

FIG. 6 illustrates an isometric view of a ball slide assembly usable with the present invention.

FIG. 7 illustrates a schematic representation of a second embodiment of a video camera system according to the present invention.

### DESCRIPTION OF THE PREFERRED EMBODIMENTS

Basic optical performance characteristics of a video camera 100 include the magnification, field of view, and resolution of a video image formed thereby; the camera spectral bandwidth; and the sensitivity or range of illumination levels at which the camera system can effectively render a useful video image. The optical elements of the camera system 100 of the present invention include a lens system 1 and two image sensors 14, 15, one adapted for rendering color scene images over the visible spectrum (e.g. 400-650 nm) in daylight or lower scene illumination levels, e.g. scenes illuminated by more than 1 lux, and another adapted for rendering monochrome or black and white scene images over a broader spectral range, (e.g. 400-1050 nm) in nightlight or any scene illumination level that is below the useful sensitivity range of the other image sensor, e.g. less than 1 lux.

The lens system 1 may comprise a single fixed lens element, but preferably will comprise a plurality of lens elements including lens elements that are movable to focus the lens system, to change the lens system field of view and/or magnification (for example from wide to narrow), and to manipulate a lens system stop aperture for adjusting illumination levels at an image plane of the lens system. Generally, the lens system 1 collects radiation being emitted or reflected by a scene and forms an image of the scene at a lens image plane. Ideally, the lens system 1 is a long focal length telescope, e.g. up to 226 mm, equipped with movable zoom elements 46, 47 for changing the field of view and magnification of the telescope. Ideally, the lens system 1 is corrected for various aberrations as required to produce a substantially diffraction limited image of a scene on a substantially planar lens image or focal plane.

In a first embodiment of the camera system 100, each image sensor 14, 15 comprises a focal plane array formed by a large number of individual image sensors (“pixels”), e.g. 300,000 sensors formed on a sensor substrate. Each sensor or pixel includes a photon or photo sensitive surface and all of the photo sensitive surfaces are substantially coplanar forming a planar active area with substantially horizontal and vertical dimensions. The planar active area of one of the sensors 14, 15 is positioned coincident with the planar image plane of the lens system 1, and the lens system forms a focused image of the scene to be imaged, hereinafter called a scene image, directly onto the active area of the focal plane array. Accordingly, each pixel of an image sensor corresponds with a small fraction of the scene image and each image sensor produces an electrical signal or photo signal in proportion to irradiance (radiant power per unit area) of the scene image at the photo sensitive surface of the image sensor. In addition, the camera system 100 is equipped to convert the photo signals into a linear digital gray scale representation of the scene image and to compile individual scene images into image frames comprising gray scale values corresponding with each pixel or sensor in the focal plane array. The image frames are then formatted according to a conventional video standard and may be displayed onto a display device or archived as required. Typically image frames are updated at a video refresh rate of 30-60 Hz.

The video resolution of the camera system 100 depends on the horizontal and vertical dimensions of the active area, on the number of pixels in the active area, the field of view or magnification of the lens system and the MTF of the lens system. When a zoom lens system is utilized, the field of view (subtended horizontal and vertical angles) is adjustable from a narrow field of view, (NFOV), to a wide field of view, (WFOV), by translating the zoom elements 46, 47 along the optical axis 45. Generally, the optical magnification of the scene image as well as the video resolution of a video image render from the scene image increase as the lens field of view narrows. Moreover, small pixels provide higher video resolution than large pixels. However, small pixels collect less total energy from the scene than large pixels and may require more scene illumination to render a useful video image. In addition, many color sensors use filters to generate a color rendering and filtered sensors may require more scene illumination to render a useful video image. To retain a high video resolution and the desired sensitivity at varying light levels, a preferred embodiment of the camera system 100 of the present invention includes two focal plane arrays 14, 15. The focal plane array 15 is a color sensor having small pixels for high image resolution and a spectral response over the visible spectral range of 400-650 nm. The sensor 14 is a monochrome or black and white sensor having larger pixels for increased sensitivity and a broader spectral response ranging over the visible spectral range of 400-650 and extending to the near infrared spectral range of 650-1050 nm, to further improve the sensitivity of the camera system. In particular, the image sensor 15 is suitable for providing color video images of scenes illuminated by typical daylight illumination levels, e.g. above 400 lux and may be suitable for providing color images down to about 1 lux of scene illumination, and the image sensor 14 is suitable for providing monochrome images of scenes illuminated by typical night time illumination levels e.g. less than 1 lux down to about 50 μlux. Moreover the preferred camera system 100 of the present invention is adapted to quickly and reliably position either one of the two focal plane arrays 14, 15 to a position coincident with the image plane of the single lens system 1 substantially without any change to the position of objects in the scene image in order to render video images of the scene using either of the two focal plane arrays. More specifically, a user may view a scene with the camera system 100 and switch between either of the focal plane arrays in order to change the sensitivity, field of view or resolution of a video image of the scene merely by changing focal plane arrays. Accordingly, the preferred camera system 100 of the present invention is usable to render video images of a scene with either of two focal plane arrays which provide sensitivity for daylight or night time illumination conditions without the need for a scene illuminator, a separate image intensifier, a fiber optic bundle coupler, or additional optical elements, other than a focal plane array, inserted into the optical path.

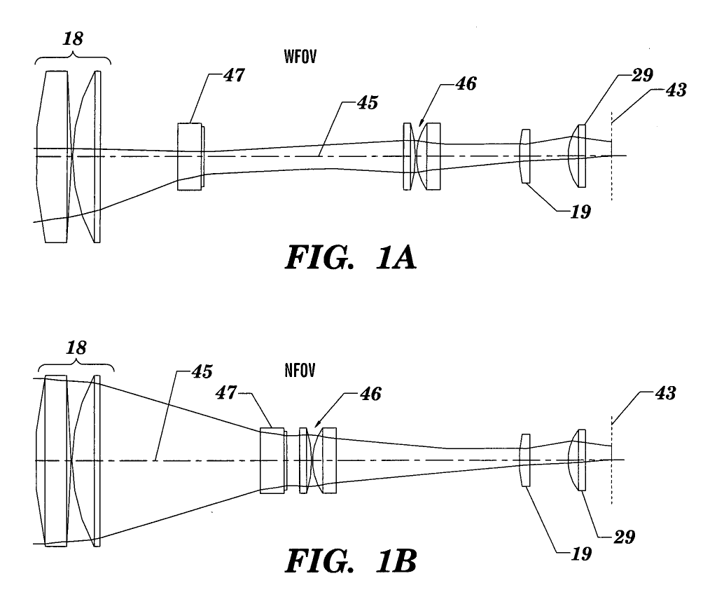

A preferred embodiment of the camera system 100 of the present invention is shown in FIGS. 1-6. Generally the camera system 100 has an optical axis 45 shown in FIGS. 1A and 1B, and the optical axis 45 is substantially coincident with a longitudinal axis of the camera system.

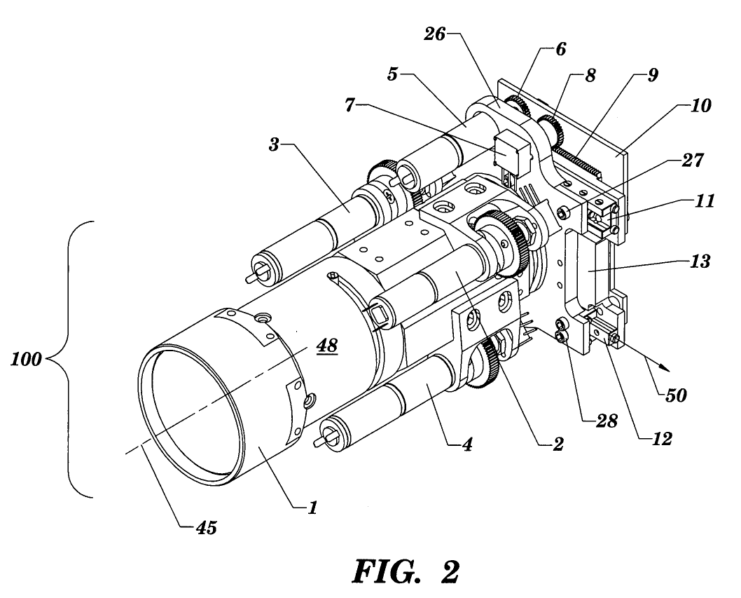

Referring now to FIGS. 1A, 1B and 2, the camera system 100 includes a telescope 1 having an objective lens pair 18, a pair of zoom lens elements 46 and 47, a focusing lens 19, and a field lens 29 all housed in a lens barrel 48 which is fixedly attached to a fixed plate 26. The telescope 1 collects radiation from a scene through the objective lens pair 18 and forms a scene image at the telescope image plane 43. As will be further described below, one of two focal plane arrays or in another embodiment one of a focal plane array and a photo sensor is positioned coincident with the image plane 43.

The zoom elements 46 and 47 are movable from first positions, shown in FIG. 1A, to second positions, shown in FIG. 1B and to intermediate positions between the first and second positions to operate the telescope 1 over a continuous range of fields of view. The telescope 1 is configured to form a scene image onto the image plane 43 with a desired image format size with horizontal and vertical dimensions sized to match horizontal and vertical dimension of the largest focal plane array 14. Moreover the telescope 1 is configured to maintain a substantially constant format size across the entire zoom range by projecting narrow and wide fields of view onto the same image format size. Accordingly, when a smaller focal plane array, e.g. 15 described below, is moved to the image plane 43, the field of view of the camera system is reduced as compared to the field of view of the camera system when the larger focal plane array is in the image plane 43. In addition when the smaller focal plane array also has smaller pixels, as is the case in the present invention, the small pixels provide a higher video resolution and a user may swap between the larger focal plane array to view a wide field at low resolution and the smaller focal plane array to view a narrow field at higher resolution.

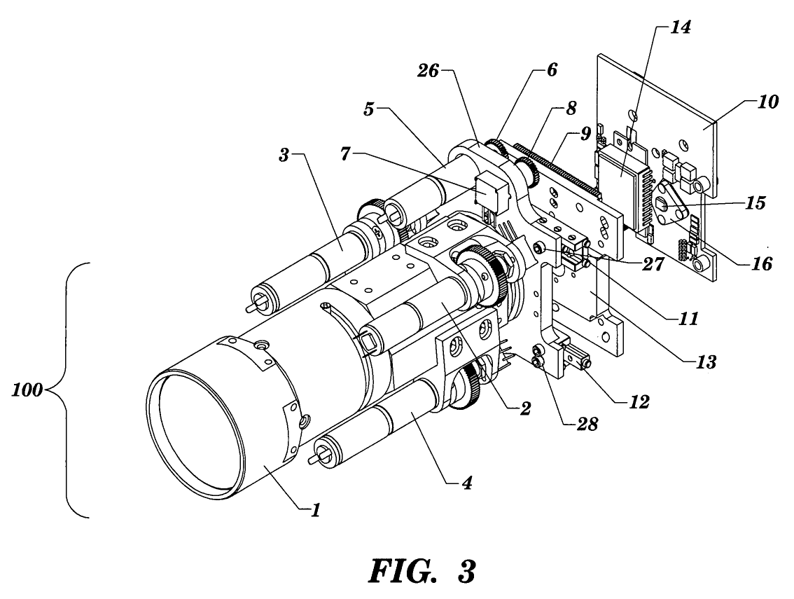

Referring to FIGS. 2 and 3, the telescope 1 includes three drive motors 2, 3, 4 and associated electrical interfaces all supported on the lens barrel 48. The drive motors 2, 3, 4 mechanically interface with the telescope to move various elements for adjusting focus, iris opening and zoom lens positions as required to operate the optical system in various configurations. The iris function can be implemented at any of several locations in the optical train, as is conventional. Although not illustrated, the telescope 1 may include other know systems such as mechanical, optical or electrical systems for focusing the scene image, for sensing and adjusting illumination levels at the scene image, for polarizing or spectrally filtering the scene image, and or for otherwise conditioning the scene image as may be required.

Referring to FIGS. 2-6 a preferred embodiment of the camera system 100 is shown in various views with identical reference numbers indicating identical or functionally equivalent elements. The camera system 100 comprises a telescope 1, fixedly supported on a fixed base plate 26. The base plate 26 also functions as a fixed mechanical interface for supporting the camera system 100 with respect to a support structure such as a fixed mounting device, not shown, with the pointing direction of the camera system is fixed, or a turret mount, or the like, with the pointing direction of the camera system movable in azimuth and or elevation. Additionally, the base plate 26 functions as a fixed mechanical interface for attaching housing or enclosure elements, not shown, to the camera system 100.

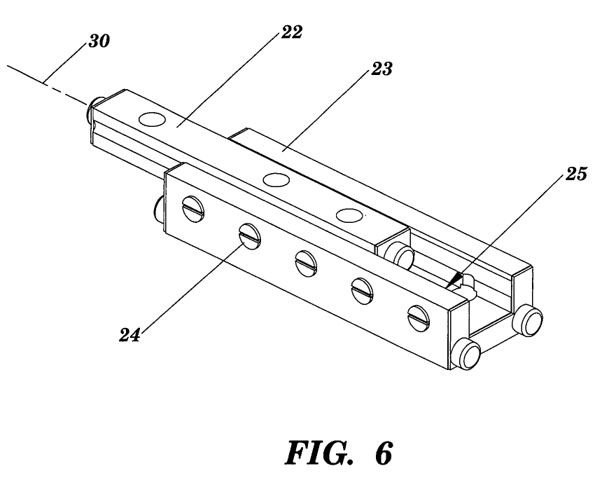

A pair of opposing ball slides 11 and 12 is mounted between the fixed base plate 26 and a movable plate 13. As shown in FIG. 6, each ball slide includes a u-shaped guide rail 23, a rectangular guided rail 22 with a plurality of balls or other rolling elements 25 disposed to rotate or roll between contacting surfaces of the rails 22 and 23 to provide a smooth low friction rolling contact between the guide rail 22 and the u-shaped guide rail 23. The ball slides 11 and 12 allow one rail 23 to move with respect to the other rail 22 along a precise linear motion axis 27. Moreover, the ball slides 11 and 12 may include adjusting screw 24 for making adjustments to the rolling elements 25 as required to eliminate play in the linear motion. Ball slides like the one Shown in FIG. 6 can be obtained from Techno Inc. in Hyde Park, N.Y.

As best viewed in FIGS. 2 and 3, the upper ball slide 11 is oriented with its rectangular guided rail 22 fixedly attached to the fixed base plate 26 by mounting screws 27 and with its u-shaped guide rail 23 fixedly attached to the movable plate 13 by mounting screws, not shown. Alternately, the lower ball slide 12 is oriented with u-shaped guide rail 23 fixedly attached to the fixed base plate 26 by mounting screws 28, and with its rectangular guided rail 22 fixedly attached to the movable plate 13 by mounting screws, not shown. The ball slides 11 and 12 are co-aligned with a motion axis 50 which is substantially perpendicular with the system optical axis 45. Accordingly, the movable plate 13 is supported for linear movement with respect to the fixed base plate 26 and the telescope 1 and the linear movement of the movable plate 13 is along the motion axis 50. Alternately, other linear slide mechanisms configured to movably support the movable plate 13 with respect to the fixed base plate 26 and other orientations of the motion axis 50 are usable without deviating from the present invention.

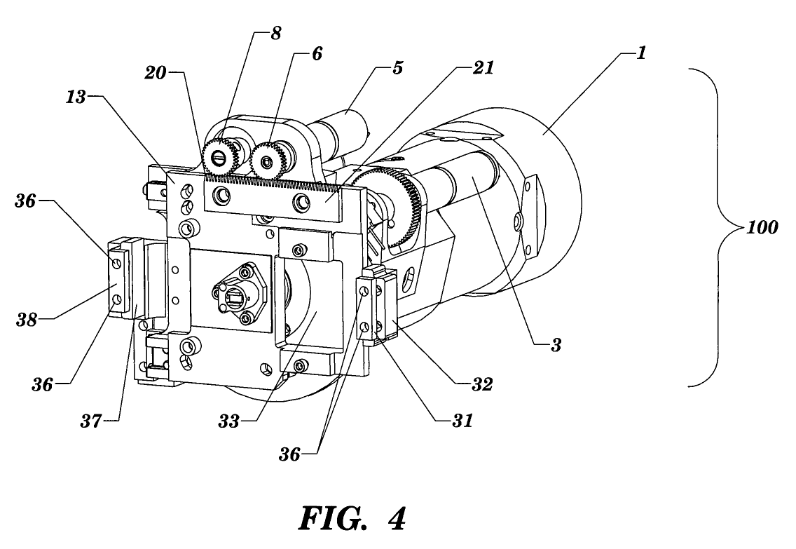

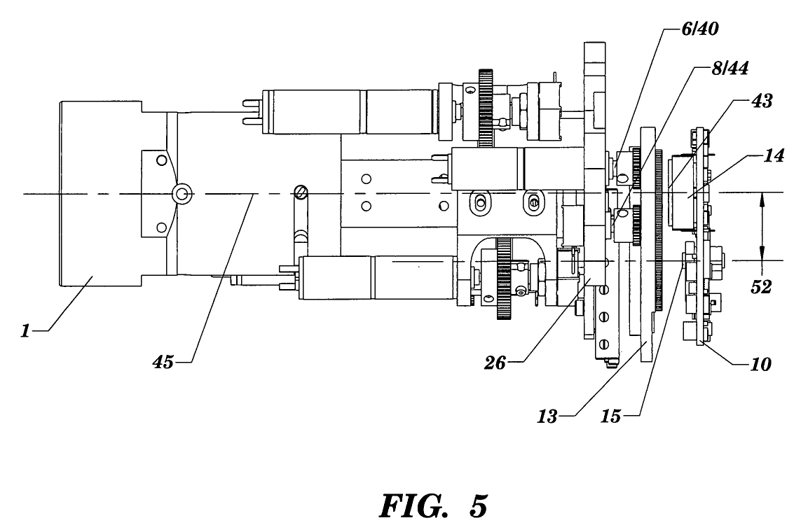

As best viewed in FIGS. 4 and 5, a rotary positioning actuator 5, such as a rotary motor, is fixedly attached to the base plate 26 and the rotary position actuator 5 includes a rotatable shaft 40 extending out there from. The actuator 5 is positioned with its rotation axis substantially parallel with the optical axis 45. A positioning gear 6 is attached to the rotatable shaft 40 for rotation therewith. A rack element 9 includes a flange portion 21 and a set of linear gear teeth 20 at a top edge thereof. The flange portion 21 is fixedly attached to the movable plate 13 and the linear gear teeth 20 are positioned substantially parallel with the motion axis 50 and engaged with the positioning gear 6. Accordingly, as the rotary position actuator 5 rotates the rotatable shaft 40 and positioning gear 6, the gear 6 drive the rack element 9 and movable plate 13 along the linear motion axis 50. Moreover, the rotary position actuator 6 is usable to drive the movable plate 13 in two directions along the motion axis 50 depending upon the direction of rotation, (clockwise or counterclockwise) of the rotatable shaft 40.

A rotary position transducer 7 such as a rotary potentiometer is fixedly attached to the base plate 26 and includes a rotatable shaft 44 extending out there from. The transducer 7 is positioned with its rotation axis substantially parallel with the optical axis 45. A transducer gear 8 is attached to the rotatable shaft 44 for rotation therewith and is positioned to engage with the linear gear teeth 20. Accordingly, as the movable plate 13 and rack element 9 are driven along the motion axis 50 by the rotary position actuator 5, the transducer gear 8 is driven to rotate the rotatable shaft 44 which causes the rotary position transducer to generate a variable electrical signal, e.g. voltage, and the variable electrical signal is substantially proportional to the position of movable plate 13 along the motion axis 50. The variable electrical signal generated by the rotary position transducer 7 is fed to an actuator controller element, not shown, used to drive the rotary positioning actuator 5 such that the movable plate 13 can be precisely driven between two positions along the motion axis 50. Moreover, according to one aspect of the present invention, the movable plate 13, ball slides 11 and 12, rotary position actuator 7 and are configured to position the moveable plate 13 in a first position along the motion axis 50 and to fixedly hold the movable plate 13 in the first position when the rotary position actuator power is turn off and thereafter to reposition the moveable plate 13 to a second position along the motion axis 50 and to fixedly hold the movable plate 13 in the second position when the rotary position actuator power is turn off. Alternately other linear and or rotary devices are usable to move the movable plate 13 between the first position and the second position, to hold the movable plate in either the first position or the second position and to sense the position of the movable plate 13 along the axis 50, without deviating from the present invention.

Referring now to FIG. 3 and 5, a sensor assembly board 10 comprises a first focal plane array 14, a second focal plane array 15 and video signal processing hardware and software associated with each focal plane array. The preferred first focal plane array 14 is a ⅓ inch black and white Electron Multiplication Charge Coupled Device, (EMCCD), capable of rendering black and white video images in low light conditions and especially in night time conditions. The active area of the first focal plane array 14 includes an array of 656×494 image sensors or pixels with each pixel having horizontal and vertical dimension of 7.4(H)×7.4(V) μm. The active area of the first focal plane array 14 has horizontal and vertical dimensions of approximately 4.9(H)×3.7(V) mm. The preferred first focal plane array 14 is commercially available from Texas Instruments of Dallas Tex. USA as part number TC253SPD-B0.

The preferred first focal plane, EMCCD 14 includes elements for performing split-gate virtual phase electron multiplication to amplify charge signals generated by the image sensors in response to scene images. The EMCCD device 14 is cooled by a Pelletier cooler incorporated within the device package. The cooler lowers the temperature of the EMCCD device 14 during operation to thereby decrease thermal signal noise generated by the device itself. The EMCCD device 14 has a usable spectral response ranging from 400-1050 nm and this allows non-visible scene energy in the spectral bandwidth of 650-1050 nm to contribute to charge signals in the individual sensors. This is especially useful when the total illumination of the scene is low and the non-visible scene energy contributes enough charge signal to noticeably improve image contrast.

The preferred second focal plane array 15 is a ⅙ inch Color Charge Coupled Device, (CCD), capable of rendering color video images in daylight light conditions. The active area of the second focal plane array 15 includes an array of 758×492 image sensors or pixels with each pixel having a horizontal and vertical dimension of 3.2 (H)×3.7 (V) 5 μm. The active area of the second focal plane array 15 has horizontal and vertical dimensions of approximately 2.45 (H)×1.84 (V) mm. The preferred second focal plane array 15 is commercially available from Sony Electronics of Tokyo Japan.

The preferred second focal plane, CCD 15 includes elements for generating color video signals over the visible spectrum ranging from 400-650 nm. In addition to providing a color image, the second focal plane array 15 advantageously has a higher video resolution than the first focal plane array 14 due to its smaller sensor dimensions. Accordingly, it is desirable to use the second focal plane array 15 in most imaging applications. However, the second focal plane array 15 is not usable to render video images of scenes having less than about 1 lux of average illumination and may have poor imaging performance (e.g. low contrast) when rendering video images of some scenes having more than 1 lux of average illumination e.g. up to about 50 lux of average illumination. In these situations, it is desirable to use the second focal plane array 14 to render video images with improved contrast.

In a further embodiment of the present invention, the second focal plane array 15 may comprise a ¼ or ⅓ inch format sensor, or any other format CCD device capable of rendering color video images in daylight light conditions, as long as the lens is designed with appropriate image plane dimensions. The active area of the ¼ inch focal plane array includes an array of 758×492 image sensors or pixels with each pixel having a horizontal and vertical dimension of 4.75 (H)×5.55 (V) μm. The active area of the ¼ inch focal plane array has horizontal and vertical dimensions of approximately 3.65 (H)×2.74 (V) mm, which is larger than the ⅙ inch format. In any case, color CCD focal plane arrays in various format sizes are commercially available from Sony Electronics of Tokyo Japan and other manufacturers and the ⅙ inch focal plane array format advantageously provides higher video resolution than either the first focal plane array 14 or the ¼ or ⅓ inch format alternate second focal plane array 15 due to its smaller sensor dimensions.

The sensor assembly board 10 is fixedly attached to the movable plate 13. As best viewed in FIG. 4, transverse motion of the movable plate 13, along the travel axis 50, is limited by adjustable stop bars 38 and 31 positioned at either end of the travel range and adjustable to set travel stops as required to stop the image sensor 14 in the lens image plane 43 at one end of the travel range and to stop the image sensor 15 in the lens image plane 43 at the other end of the travel range. The adjustable stop bar 38 is moveably supported on a bracket 37 which is fixedly attached to the fixed plate 26. The stop bar 38 attaches to the bracket 37 by a pair of fasteners 36 and the orientation and transverse position of the adjustable stop bar 38 may be adjusted to set a first travel stop. At the opposite end of the travel range, the stop bar 31 attaches to a fixed bracket 32 by a pair of fasteners 36 and the orientation and transverse position of the adjustable stop bar 31 may be adjusted to set a second travel stop. The fixed bracket 32 is fixedly attached to the fixed plate 26.

The movable plate 13 includes a rectangular through aperture 33 and the sensor assembly board 10 mounts to the movable plate 13 with each the first focal plane array 14 and the second focal plane array 15 positioned with its active areas supported within the aperture 33 and facing the telescope 1. As is further shown in FIG. 4, the fixed base plate 26 also includes a through aperture surrounding the optical axis 45 for positioning active surfaces of one or the other of the focal plane array 14, 15 in the telescope image plane 43. As best viewed in FIG. 5, the first focal plane array 14 is supported on the sensor assembly board 10 with its active area coplanar with the telescope focal plane 43 and with its central axis substantially coincident with the telescope optical axis 45. Moreover, FIG. 5 depicts the movable plate 13 positioned at a first position which specifically locates the active area of the first focal plane array 14 in an imaging position coplanar with the telescope image plane 43 so that the telescope 1 forms a scene image onto the active area of the first focal plane array 14. Accordingly, when the movable plate 13 is in the first position the camera system 100 is configured for night time or other low light video imaging operations. In addition, with the movable plate 13 in the first position, the size of the scene image formed in the image plane 43 is substantially matched to the size of the active area of the first focal plane array 14 and the camera system 100 produces a monochrome video image of the entire field of view at a first video resolution.

The second focal plane array 15 is supported on the sensor assembly board 10 with its active area coplanar with the telescope focal plane 43 and with its central axis offset from the telescope optical axis 45 by an offset dimension 52. According to the present invention, the rotary positioning actuator 5 is activated to move the movable plate 13 from the first position shown in FIG. 5 to a second position that specifically locates the second focal plane array 15 in the imaging position, coplanar with the telescope image plane 43 so that the telescope 1 forms a scene image onto the active area of the second focal plane array 15. Accordingly, the rotary actuator 5 is activated to move movable plate 13 over the distance 52 to a second position to configure the camera system 100 for color video imaging in daylight conditions. In addition, with the movable plate 13 in the second position, the size of the scene image formed in the image plane 43 is larger than the size of the active area of the second focal plane array 15 and the camera system 100 produces a color video image of less than the entire field of view at a second video resolution that is higher than the first video resolution produced by the first focal plane array 14.

The rotary transducer 7 is usable to control the rotary actuator 5 to precisely and repeatabley move the movable plate 13 between the first and second positions as required for imaging. Additionally, the camera system 100 may be configured to automatically change its imaging mode by moving the movable plate 13 from the first position to the second position and back in response to changing scene conditions. In particular, the camera system 100 may be configured to position the movable plate 13 in the second position to utilize the higher resolution color CCD 15 for imaging as a default imaging state and to automatically move the movable plate 13 to the second position in response to low illumination conditions in the scene being imaged. Alternately, the camera system 100 includes an operator input control feature for selecting the position of the movable plate 13 according to a desired imaging mode selected by the operator.

In a preferred embodiment, each focal plane array 14 and 15 is precisely positioned as required to position its active area coplanar with the telescope image plane 43 and to position its central axis coaxial with the system optical axis 45. In particular, it is desirable that the central axis of each focal plane array 14 and 15 is co-aligned with the optical axis 45 within about one pixel, or approximately within about 3-7 μm, when the selected focal plane array is in the imaging position. This allows the camera system to be operated with image position repeatability when changing from one focal plane array to the other. More specifically, the camera system 100 is configured so that the position of each target object in an image of a fixed scene is substantially repeatable whether rendering the image with the first or the second focal pane array.

Accordingly, the preferred camera system 100 includes alignment features such as the bracket 37 and adjustable bar 38 used to orient the sensor assembly 10 with respect to the movable plate 13. Additionally, a bracket 32 is mounted to the fixed base plate 26 and an adjustable bar 31 is usable to establish an end stop for contacting and stopping the motion of the movable plate 13 when the movable plate 13 reaches the first position. In addition, each of the focal planes arrays 14 and 15 may be adjustably supported on the sensor assembly board 10 with vertical and or horizontal adjusting features incorporated into the mounting hardware in order to align central axis of each focal plane array with the optical axis 45, e.g. while the camera system is imaging an alignment target.

The camera system 100 as described above provides a versatile surveillance device usable for color daylight or black and white night time imaging. In addition, the camera system 100 as described above allows an operator to increase the range of optical resolution and the range of field of view by changing image sensors. In particular, with the ⅓ inch sensor (first focal plane 14) in the imaging position, the camera system 100 has an F/# capability ranging from F/6-F/22, an optics effective focal length of 22.6-226 mm, a WFOV of 12.26 degrees horizontal×9.28 degrees vertical and a NFOV of 1.23 degrees horizontal×0.93 degrees vertical. Alternately, with a ⅙ inch sensor (second focal plane 15) in the imaging position the camera system 100 has an F/# capability ranging from F/6-F/22, an optics effective focal length of 22.6-226 mm, a WFOV of 6.22 degrees horizontal×4.69 degrees vertical and a NFOF of 0.62 degrees horizontal×0.47 degrees vertical. As a further alternative, when the camera system 100 is configured with a ¼ inch sensor, (alternate second focal plane 15), the camera system 100 has an F/# capability ranging from F/6-F/22, an optics effective focal length of 22.6-226 mm, a WFOV of 9.25 degrees horizontal×6.95 degrees vertical and a NFOF of 0.925 degrees horizontal×0.695 degrees vertical.

In further alternate embodiments, the camera system 100 may be configured with other sensor pair combinations, e.g. with two visible spectrum color CCD sensors each having a different format size, e.g. a ⅓ inch sensor and a ⅙ inch sensor, or two ⅓ inch sensors each having a different spectral bandwidth, e.g. one visible wavelength sensor (e.g. over the wavelength range of 450-600 nm) and one infrared wavelength sensor, (e.g. over the wavelength range of 3-5 μm). In further alternate embodiments, the camera system 100 can be configured to include three focal plane arrays each movable to the imaging position for a different application.

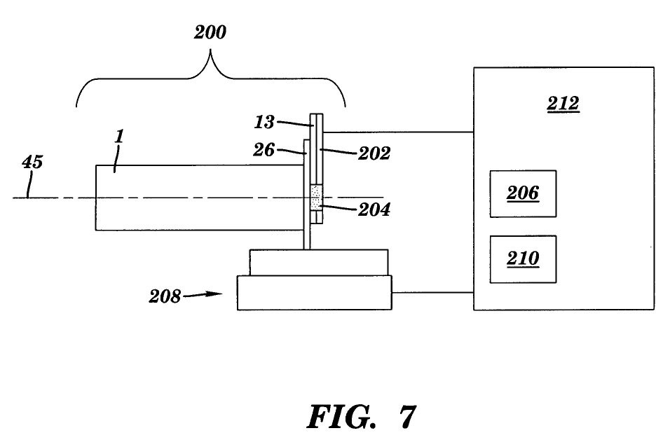

Turning now to FIG. 7, a second camera system 200 according to a further embodiment of the present invention includes a telescope 1, a fixed plate 26 and a movable plate 13 all as described above. The camera system 200 includes a sensor assembly board 202 attached to the movable plate 13 and the sensor board 202 includes the first detector 14 which is positioned coincident with the image plane 43 when the movable plate 13 is in the first position, also as described above. The first detector 14 comprises the same low light focal plane array 14 described above. The sensor board 200 includes a second photo sensor comprising a photo diode configured as a conventional quadrant detector 204, and the sensor board 200 is configured to position quadrant detector 204 coincident with the image plane 43 when the movable plate 13 is in the second position which is the position of the movable plate 13 shown in FIG. 7.

The quadrant detector 204 is configured with four sensing quadrants each generating an electrical signal in proportion to the irradiance of the scene image in the corresponding sensing quadrant. In addition, the camera system 200 includes a quadrant detector signal processor 206 configured to receive electrical signals from the quadrant detector 204 and to provide electrical feedback signals usable to determine when the irradiance of the scene is equal on each of the four sensing quadrants. Accordingly feedback from the quadrant detector signal processor 206 is usable to point the camera optical axis 45 at the center of a bright object in a scene. In particular, the camera system 200 is configured to be precisely pointed at an illuminate target within the field of view of the telescope 1.

The camera system 200 includes a motorized gimbal mount 208 attached to the fixed plate 26 or a camera system housing, not shown, for pointing the camera system optical axis 45 in desired pointing directions. Preferably, the motorized gimbal mount 208 is configured to rotate the camera system over a range of azimuth angles using a rotation about a vertical axis, and to rotate the camera system over a range of elevation angles using a rotation about a horizontal axis to thereby roughly point the optical axis 45 at a scene of interest and to more finely point the optical axis 45 at a target area within the scene or interest. Alternately the motorized gimbal mount 208 may provide only one rotation axis or may provide rotation about other axes without deviating from the present invention.

The camera system 200 further includes a gimbal mount controller 210 and a system controller 212. The system controller 212 controls all aspects of system operation including control of the gimbal mount controller 210, movement of the movable plate 13, operation of the telescope 1, all video image processing, displaying video images on one or more display devices, receipt and processing of user input commands, including user input commands generated by a user operated joy stick for pointing the camera optical axis 45 at a scene, providing power, controlling external communication, storing video images on a storage device, and any functions as may be required to operate the camera system 200. The gimbal mount controller 210 interfaces with the system controller 212 and the motorized gimbal mount 208 as required to point the camera optical axis 45 at a scene or a target within the scene according to a user input command or program steps operating on the camera system controller 212. In addition, the quadrant detector signal processor 206 interfaces with the system controller 212 and or the motorized gimbal mount controller 210 to provide feedback for pointing the optical axis 45 at the center of an illuminated target within the field of view of the telescope 1.

In operation, a user of the camera system 200 positions the movable plate 13 in the first position thereby placing the first focal plane array 14 coincident with the telescope image plane 43 such that the camera system 200 generates and displays video images of whatever scene is within the field of view of the telescope 1. In addition, the user may set the telescope at its widest field of view to view larger scene areas. The user may then view video images being generated by the camera system on a display device in communication with the camera system controller 212 and pan and tilt the camera pointing axis 43 using a joy stick or other means in communication with the camera system controller 212 and or the gimbal mount controller 210. The user may then select a scene that includes an illuminated target, or other interesting illumination pattern, and roughly point the camera optical axis 45 using the joy stick to approximately center the illuminated target in the scene image. Thereafter the user enters a command to move the movable plate 13 to the second position to thereby position the quadrant detector 204 coincident with the image plane 43 and commands the system controller 212 to operate the gimbal mount controller 210 using feedback from the quadrant detector 204 to precisely point the camera optical axis 45 at the center of the illuminated target. Once the camera optical axis 45 is centered on the illuminated target, the user enters a command to move the movable plate 13 back to the first position to again position the first focal plane array 14 coincident with the image plane 43 and to resume generating video images of the illuminated target. The user may then enter commands to narrow the telescope field of view as desired to increase video resolution and image magnification as desired.

Hence, it will be recognized by those skilled in the art that, while the invention has been described above in terms of preferred embodiments, it is not limited thereto. Various features and aspects of the above described invention may be used individually or jointly. Further, although the invention has been described in the context of its implementation in a particular environment, and for particular applications, those skilled in the art will recognize that its usefulness is not limited thereto and that the present invention can be beneficially utilized in any number of environments and implementations where a camera system is used to render video images of scenes having differing illumination conditions, or to render video images over differing spectral ranges. Accordingly, the claims set forth below should be construed in view of the full breadth and spirit of the invention as disclosed herein.

1. A video camera system for rendering a video image of a scene, comprising:
an optical system having an field of view centered by an optical axis and optical elements configured to form a focused scene image at an image plane;
a fixed base plate for fixedly supporting the optical system;
a movable plate movably supported with respect to the fixed base plate for movement along a linear motion axis that is substantially orthogonal to the optical axis;
a sensor assembly fixedly attached to the movable plate comprising a plurality of optical sensors each having a substantially planar photo active area centered by a central axis suitable for generating electrical signals in proportion to an irradiance level generated by the scene image; and,
an actuator disposed between the fixed base plate and the movable plate for moving the movable plate along the linear motion axis to position any one of the plurality of optical sensors to an imaging position wherein the active area of the optical sensor in the imaging position is substantially coplanar with the image plane and the central axis of the optical sensor in the imaging position is substantially coaxially aligned with the with the optical axis.

2. The video camera system of claim 1 further comprising a position transducer and transducer actuator elements disposed between the fixed base plate and the movable plate for generating a variable electrical signal in response to movement of the movable plate along the linear motion axis.

3. The video camera system of claim 2 further comprising one or more linear slide mechanisms mounted between the fixed base plate and the movable plate for sliding the movable plate along the linear motion axis with respect to the fixed base plate.

4. The video camera system of claim 3 wherein the one or more linear slide mechanisms comprises a pair of opposing ball slides each having a slide linear motion axis that is aligned with the linear motion axis.

5. The video camera system of claim 4 wherein the plurality of optical sensors comprises a first optical sensor and a second optical sensor separately movable to the imaging position further comprising:
a first end stop attached to the fixed base plate and disposed to stop motion of the movable plate along the linear motion axis in a first direction when the first optical sensor is in the imaging position; and,
a second end stop attached to the fixed base plate and disposed to stop motion of the movable plate along the linear axis in a second direct, opposed to the first direction, when the second optical sensor is in the imaging position.

6. The video camera system of claim 5 wherein the actuator comprises:
a rotary actuator attached to the fixed base plate;
a rotatably shaft extending out from the rotary actuator and disposed with a rotation axis oriented substantially parallel with the optical axis and orthogonal with the linear motion axis;
a circular gear attached to the rotary shaft for rotation therewith;
a rack element comprising a set of linear gear teeth disposed along a longitudinal axis fixedly attached to the movable plate with the longitudinal axis oriented substantially parallel with the linear motion axis; and,
wherein the circular gear engages with the linear gear teeth to drive the movable plate in two directions along the linear motion axis in response to clockwise and counterclockwise rotation of the rotary actuator.

7. The video camera system of claim 1 wherein the plurality of optical sensors comprises a first optical sensor configured as a monochrome focal plane array electron multiplication charge coupled device and a second optical sensor configured as a color focal plane array charge coupled device.

8. The video camera system of claim 1 wherein the plurality of optical sensors comprises:
a first optical sensor for rendering video images of scenes having a low average illuminance with a usable spectral response over a wavelength range at least including a portion of the visible spectral range of 450-650 nm and a portion of the near infrared spectral range of 650-1050 nm; and,
a second optical sensor for rendering video image of scenes having a higher average illuminance with a usable spectral response over at least a portion of the visible spectral range of 450-650 nm.

9. The video camera system of claim 1 wherein the plurality of optical sensors comprises:
a first optical sensor having first active area dimensions and first pixel dimensions for forming a video image with a first video resolution; and,
a second optical sensor having second active area dimensions and second pixel dimensions for forming a video image with a second video resolution.

10. The video camera system of claim 1 wherein the optical system comprises a telescope equipped with movable zoom elements for forming scene images over a range of fields of view.

11. A camera system comprising:
a telescope optical system for forming a scene image at an image plane;
a fixed base plate for supporting the telescope optical system;
a movable plate supported for movement along a linear motion axis with respect to the fixed base plate;
a first focal plane array, having an active area suitable for generating image signals in response to an image being formed thereon, fixedly attached to the movable plate at a first position;
a second focal plane array, having an active area suitable for generating image signals in response to an image being formed thereon, fixedly attached to the movable plate at a second position;
first means for rendering a video image based on the image signals generated by the first focal plane array;
second means for rendering a video image based on the image signals generated by the second focal plane array; and,
actuator means disposed between the fixed base plate and the movable plate for moving the movable plate along the linear motion axis to position one of the first focal plane array and the second focal plane array at an imaging position wherein the active area of the focal plane array at the imaging position is substantially coplanar with the image plane.

12. The camera system of claim 11 wherein the telescope optical system includes an optical axis, the image plane includes a central axis coaxial with the optical axis and each of the first and second focal plane arrays includes an array central axis, wherein the actuator means is configured to position the array central axis of each of the first and second focal plan arrays to within one pixel of being coaxial with the image plane central axis when the focal plane array is at the imaging position.

13. The camera system of claim 12 wherein the actuator means comprises a pair of ball slides comprising first elements fixedly attached to the fixed base plate and second elements movable along the linear motion axis with respect to the first elements, wherein the ball slide first elements are substantially parallel with each other and substantially orthogonal to the optical axis.

14. A method for rendering video images comprising the steps of:
supporting an optical system on a fixed base plate;
forming a scene image at an image plane of the optical system;
supporting a plurality of optical sensors on a moveable plate movably supported for motion along a linear motion axis with respect to the fixed base plate and the image plane;
translating the movable plate with respect to the image plane to position a selected one of the plurality of optical sensors at an imaging position to thereby form the scene image onto a photo active surface of the optical sensor positioned at the imaging position; and,
rendering a video image of the scene image with the selected one of the plurality of optical sensors.

15. The method of claim 14 wherein the plurality of optical sensors comprises a first optical sensor configured as a monochrome focal plane array electron multiplication charge coupled device suitable for rendering video images with 1 lux or less of scene illuminance, and a second optical sensor configured as a focal plane array charge coupled device suitable for rendering video images with 1 lux or more of scene illuminance further comprising the step of:
selecting one of the first optical sensor and the second optical sensor according to a scene illuminance level as required to render a suitable video image of the scene.

16. The method claim 15 wherein the plurality of optical sensors comprises a first focal plane array configured with first pixel dimensions suitable for generating a video image of the scene image with a video resolution and a second focal plane array configured with second pixel dimensions suitable for generating a video image of the scene image with a second video resolution further comprising the step of:
selecting one of the first focal plane array and the second focal plane array for generating the video image of the scene image with one of two video resolutions.

17. The method of claim 14 wherein the plurality of optical sensors comprises a first focal plane array configured with a useful spectral sensitivity range of 450-1050 nm and a second focal plane array configured with a useful spectral sensitivity range of 450-650 nm, further comprising the step of:
selecting one of the first optical sensor and the second optical sensor according to a scene illuminance level as required to render a suitable video image of the scene.

18. The method of claim 14 further comprising the steps of:
generating a variable electrical signal in response to movement of the movable plate; and,
using the variable electrical signal to precisely drive the movable plate to a plurality of different positions suitable for positioning the selected one of the plurality of optical sensors at the imaging position.

19. The method of claim 14 wherein the plurality of optical sensors comprises a first optical sensor and a second optical sensor and wherein the step of translating the movable plate with respect to the fixed base plate and the image plane further comprises the steps of:
moving the movable plate in a first direction until it contacts a first end stop suitably located for positioning the first optical sensor at the imaging position; and,
moving the movable plate in a second direction until it contacts a second end stop suitably located for positioning the second optical sensor at the imaging position.

20. A method for operating a video camera comprising the steps of:
supporting an optical system on a fixed base plate;
supporting the fixed base plate on a motorized gimbal mount configured to point the optical system;
forming a scene image at an image plane of the optical system;
supporting two optical sensors on a moveable plate supported for motion along a linear motion axis with respect to the fixed base plate and the image plane;
translating the movable plate to position a first optical sensor configured as a focal plane array at an imaging position wherein the scene image is formed onto an active area of the focal plane array and converted to a video image of the scene image;
viewing a video image of the scene image to find an illuminated target in the scene image;
translating the movable plate to position a second optical sensor configured as a quadrant detector at the imaging position wherein the quadrant detector generates electrical signals in proportion to irradiance values in each of four quadrants of the scene image;
processing the electrical signals generated by the quadrant detector and driving the motorized gimbal mount to point the camera system at a center of the illuminated target.
